(19) United States
(12) Patent Application Publication
(10) Pub. No.: US 2004/0064329 A1
(43) Pub. Date: Apr. 1, 2004

(54) Computer network based employment application system and method

(75) Inventors: Brenda Broad, North Haven, CT (US); Frank C. Bartsch, Leesburg, VA (US)

Correspondence Address: ROTHWELL, FIGG, ERNST & MANBECK, P.C., 1425 K STREET, N.W., SUITE 800, WASHINGTON, DC, 20005, US

(73) Assignee: Koninklijke Ahold NV

(21) Appl. No.: 10/315,071

(22) Filed: Dec. 10, 2002

Related U.S. Application Data
(60) Provisional application No. 60/337,119, filed on Dec. 10, 2001.

(51) Int. Cl. G06F 17/60

(52) U.S. Cl. 705/1

(57) ABSTRACT

A computer network based employment application system and method is disclosed. The system may be employed by companies having multiple locations throughout one or more regions. The hiring process, application screening, and applicant selection may be performed over a computer network linked to the different locations. Applications are entered on-line and placed in an applicant source pool. The applicant source pool is accessible from the computer network. The applicant source pool is screened for candidates when a need arises within the company. By using the applicant source pool, applicant information retrieval is automated.

### CROSS REFERENCE TO RELATED APPLICATIONS

This application claim benefit of U.S. Provisional Patent Application No. 60/337,119 entitled “Computer Network Based Employment Application System and Method,” filed Dec. 10, 2001, which is hereby incorporated by reference.

### BACKGROUND OF THE INVENTION

1. Field of the Invention

The present invention relates to on-line, computer-network-based, employment application processes, such as processes using the Internet or other computer networks. More particularly, the invention relates to an employment application system and method that are connected via a network connecting multiple locations.

2. Discussion of the Related Art

Current employment application processes may involve intensive time, resources, and overhead commitments. Further, inefficiencies and errors in processing employment applications frustrate employers and potential employees.

### SUMMARY OF THE INVENTION

Accordingly, the present invention is directed to a computer network based employment application system and method.

The preferred embodiments of the present invention can provide a novel means for handling a hiring process (e.g., an application, screening and selection process) and for making the hiring process more efficient, effective and/or consistent. In preferred embodiments, this automated process decreases manager involvement in the initial application process by screening and selecting the best candidates.

The preferred embodiments may employ a screening process to improve integrity, customer service and/or to reduce employee turnover. The preferred embodiments can also help reduce turnover by putting applicants through a behavioral assessment allowing a company to automatically screen out those applicants who are at a high risk to turnover. In some cases, past behavior can be a predictor of future behavior. Some preferred embodiments may allow a user to screen for specific preferred behavior types, such as behaviors associated with customer service in alignment with our certain customer service strategic plans. Some embodiments may enable a company to screen an applicant's integrity and/or their likeliness to turnover.

The preferred embodiments are incorporated over a computer network, such as, most preferably, over the Internet, whereby potential employees or applicants may apply via one or more server computer(s) that create a web page or the like through a user interface provided to the users at their remote computers that are connected to the Internet using browser software executing on their remote client computer. For example, the communication can include hyper text transfer protocol (http) requests and responses between the server and client computers. In preferred embodiments, the remote client computers may include, for example, personal computers, desk top computers, laptop computers, personal digital assistants or any electronic computer device capable of communicating over a computer network, such as the Internet, world-wide-web, a wide area network, a local area network, or the like. Accordingly, the system enables users to apply for employment, for example, in convenience of their homes.

In the most preferred embodiments, a computer is provided at a workstation or kiosk that is provided at a location within a company building, office or retail site, such as in some preferred embodiments at a commercial establishment, such as at a retail store such as a grocery store or other retail location. Preferably, each location at which employment may be obtained may include one or more kiosk at a location to enable prospective employees to enter the establishment and complete an application for employment at that location. The computer is preferably configured so as to provide an interface to the web site so as to enable applicants for employment to enter the establishment and apply for employment on site at that establishment.

In preferred embodiments, the system can assist store managers by increasing the applicant base by enabling the centralizing of an applicant pool and releasing applicants to more than one store or location, such as within a certain geographic region (e.g., local to the applicant or the like). Thus, for example, an applicant that applies for employment at one location may be considered for employment at another location.

Preferably, the system provides access to a detailed applicant report that will highlight the applicant's strengths and/or potential areas of concern, potentially resulting in better hiring decisions, less turnover and/or greater retention.

In illustrative embodiments, applicant recruiting, screening and selection may be enhanced to create a more efficient, effective and/or consistent process via web-based technology. In some illustrative cases, the process may deliver a significant reduction in turnover.

In some preferred embodiments, the system preferably may operate having the following features, as follows: target external candidates for retail union and/or non-union positions; be available 24/7/365 with over 99% up time; be locally identifiable by an specific company (e.g., an operating company or “OpCo”); communicate a list of open positions to interested applicants; be an easy application for retail applicants and/or managers to use; be accessible via an in-store kiosk and/or a link from an operating company's website; require the entry of data fields that must be completed before an application will be accepted; integrate with vendors for WOTC1; integrate with vendors for background checks; integrate with vendors for drug testing; deliver a secure system to prevent unauthorized access; deliver multi-store access to applicants for designated individuals; check for duplicate applications; be easily upgraded to future releases; provide a full system backup and plan for disaster recovery; include an initial on-line assessment; deliver assessment results to the store manager within about 10 minutes of completion; offer interviewer tips and interview questions for follow-up; provide managers with a list of qualified applicants on demand and/or be able to prioritize them by the most qualified; provide a timed reset of the system if someone abandons the application process; allow the applicant to manually cancel out of the application process if desired; offer the ability to modify job openings; capture data regarding where and when an applicant applied; include an applicant tracking mechanism to allow the store manager to see where each applicant is in the hiring process; include an applicant tracking mechanism to validate the absence of adverse impact in the hiring process; deliver reporting for various locations and organizational levels; accumulate diversity data and don't report it to the hiring manager; interface with Human Resource Management Software systems (such as that of Cyborg Systems, Inc.); check for previous work history at the company (e.g., operating company); check social security number (SSN) and/or names; conduct U.S.P.S. Coding Accuracy Support System (CASS) certifications; feed information to an imaging system; provide an on-line environment for marketing (e.g., via advertisements to associates, applicants or the like); ensure that “no rehires” are made of former associates with a status or flag of “no rehire;” provide a shared pool of screened applicants (e.g., after a predetermined time period, such as for example 72 hours)(e.g., with other stores in vicinity, area or region); provide an on-line environment for internal job posting of opportunities available; -provide an on-line environment for internal job posting of opportunities available; compare employee competencies (e.g., employee competencies may be retained in the system) with requirements for new positions and determine the applicability of employees for such new positions (e.g., preferably even without the employee's application for the position), such that pro-active job matching may be conducted for such opportunities. ¹ The Work Opportunity Tax Credit (WOTC), authorized by the Small Business Job Protection Act of 1996 (P.L. 104-188), is a federal tax credit that encourages employers to hire eight targeted groups of job seekers by reducing employers' federal income tax liability. WOTC encourages employers to hire members of targeted groups with barriers to employment.

The WOTC is one tool in a diverse toolbox of flexible strategies designed to help people move from welfare to work and gain on-the-job experience. It joins other education and job training initiatives and targeted tax credits, that help American workers prepare for good jobs; ease the transition from job to job; and create high performance workplaces.

Preferred embodiments can fulfill one or more of the following and/or other benefits, objectives and/or purposes: delivering outstanding human resource services; optimizing and standardizing HR business processes that support the standardization of HR data and information systems across a group of affiliated companies and/or entities; providing store managers a superior screening and selection system that increases the quantity and quality of qualified applicants; delivering to the associates the ability to access and maintain personal, payroll, and benefit information with the added benefit of having access to company communications all via the World Wide Web, the Internet or the like; giving the store managers a system that expedites their human resource management responsibilities, providing them more time to execute revenue-generating activities.

The preferred embodiment can impact the following and/or other areas of business: all affiliated entities' (e.g., operating companies) human resources and/or payroll functions, store operations and/or each individual associate.

The system may also provide the following and/or other features: improved HR/Payroll administrative processes; reduced IT support costs; improved candidate selection; reduced turnover; more efficient use of store managers' time; provide store managers a superior screening and selection tool that increases the quantity and quality of the candidate pool; provide store managers a system to expedite human resources administrative responsibilities, as a result, the net gain in time will allow the store manager to spend more developmental time with associates and in revenue generating activities; allow associates the ability to maintain personal data and give access to payroll and benefit information; communicate to associates via an open network, such as the Internet or the World Wide Web; elimination of redundant administrative work at multiple locations.

In some illustrative embodiments, systems may be provided that perform one or more of the following: capturing HR economies of scale; standardized HRIT; standardized business processes; employee self service; manager self service; applicant screening and selection; realignment of HR organizations to support a new business model; increasing intellectual capital faster than the speed of organizational change.

The above and other aspects, features and/or benefits of various embodiments of the invention will be appreciated by those in the art based on the following detailed description along with the accompanying drawings.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a process flow diagram of recruiting and staffing according to some illustrative embodiments.

FIG. 2 is a process flow diagram of candidate selection according to some illustrative embodiments.

FIG. 3 is a process flow diagram of external applicant initial screening according to some illustrative embodiments.

FIG. 4 is a process flow diagram of on-line application and initial screening according to some illustrative embodiments.

FIG. 5 is a process flow diagram of new hire authorization for external store applicants according to some illustrative embodiments.

### DETAILED DESCRIPTION OF THE PREFERRED EMBODIMENTS

Reference will now be made in detail to the preferred embodiment of the present invention, examples of which are illustrated in the accompanying drawings. In preferred embodiments, a system is provided that can facilitate the employment application, hiring and/or related processes for an entity or, more preferably, a group of affiliated entities, such as an entity including a plurality of operating companies.

Preferred embodiments include a system that provides a web site provided via a web server that can be accessed via the Internet or the like via remote client computers using TCP/IP, Http and other protocol. In the most preferred embodiments, the web site can also be accessed via on-site locations having computer workstations or kiosks. Specifically, the on-site locations preferably include locations at or proximate to the place or establishment at which an applicant for employment seeks a position. Accordingly, an applicant can preferably enter an establishment at which the applicant desires to obtain employment and can apply at the specific kiosk.

In preferred embodiments, the kiosk includes a table or structure that supports a computer display and computer keyboard. The kiosk computer may also be contained within the kiosk in preferred embodiments. The kiosk computer is preferably connected via a communications link so as to be in communication with the web site provided for the system. Preferably, the kiosk computer is programmed such that it displays and/or accesses that particular web site during use by patrons of the establishment or applicants. Preferably, the kiosk computer is also programmed so as to identify a particular location identification number to the web site server, whereby the web site server can identify the location at which the application is being made. In this manner, the web site may show the applicant only employment opening listings at that particular establishment (and/or potentially within a particular region near thereto) without the applicant specifically identifying which location the applicant seeks employment. For example, the kiosk computer may be programmed to include a kiosk identifier at the end of the URL for the particular web site, such as, for illustrative purposes: http :www.aholdusaHRwebsite.com/kioskID or http:www.aholdusaHRwebsite.com?kioskID (e.g., to direct the user to a particular section of the same web site, to enable the web server to execute programming to provide information solely for that kiosk location or, accordingly, that store in which the kiosk is located, or the like).

Most preferred embodiments, include multiple store, office or other business locations contained respective kiosks. Additionally, the kiosks preferably have kiosk IDs that are unique to a particular set of business locations or, more preferably, to an individual store.

In some more preferred embodiments, the kiosks are located within a plurality of retail stores of one entity or a group of affiliated entities. In preferred embodiments, at least some of the retail stores are food and the like stores, such as grocery stores, like that of GIANT FOODS, INC.™ or the like. Positions that may be posted can include various positions at these stores, such as merely some examples: cashiers, bagging persons, deli persons, pharmacy assistants and more. In some other preferred embodiments, kiosks can be located at distribution centers for various entities. In some preferred embodiments, the distribution centers can include food and the like distribution centers, such as those related to distribution to retail stores such as those described above. In alternative embodiments, kiosks can be located within corporate or business centers other than retail or distribution centers. Preferably, in any of these cases, kiosks are located and programmed such that users can walk into the desired locations and apply for employment at that particular establishment via the kiosks.

In the most preferred embodiments, applicants will only be allowed to apply via the system, such as via the kiosks or via the Internet. In this manner, the entire applicant pool can be readily documented and managed. Additionally, by including an on-line application interface (e.g., via the Internet or the like), kiosks can be located in any desired place—e.g., and may even include wireless communications to the Internet. Accordingly, at job fairs or other situations, kiosks can be located (even temporarily) that will allow applicants to apply via the same web site and to even enable the easy record keeping of results and the like of applicants.

In some preferred embodiments, the kiosks can be used, not only for new applicants to apply for positions, but also for existing employees to access various employee data or information personal to that employee. To that end, employees preferably are given usernames and passwords and the system is adapted to provide a secure connection so as to present personal information to that employee (e.g., such as salary information and various other information). Alternatively, separate employee-only kiosks may be provided at separate locations within the establishment (e.g., in store areas or other employee only areas).

Additionally, various preferred embodiments can include novel processes and systems in regards to one or more of the following: Recruiting and Staffing; Candidate Selection; External Application Initial Screening; Online Application and Initial Screening; and/or New Hire Authorization.

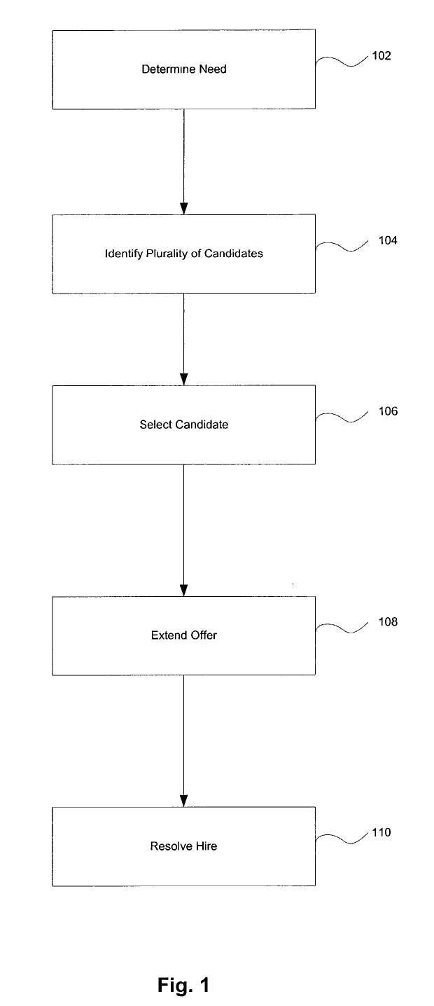

FIG. 1 depicts a process flow diagram of recruiting and staffing by selecting a candidate from an applicant source pool according to the disclosed embodiments. Step 102 executes by determining a need for candidate within a company. The need may correlate with certain criteria or desires of the company. With respect to recruiting and staffing, in preferred embodiments of the invention, staffing may include one or more processes and/or process steps disclosed with reference to FIG. 1. Further, with reference to FIG. 1, the strategic plan of the operation company or entity is the plan that drives the human resource requirements.

Step 102 may be supplemented by inputting local work force strategy. Process inputs under local work force strategy may include, for example: requisitioning, budgets, seasonal needs, size of store, succession planning (cross training), and development. With reference to FIG. 1, the technology platform to implement this step may include, for example: Applicant Tracking Position Management; Excel; Database; Labor Systems; Web Servers and Modeling; CBT Training; Succession Planning Software; LMS.

Step 102 may supplemented by implementing strategy to determine the need for the candidate. With reference to FIG. 1, the process inputs under implementation of strategy may include, for example: transfers, promotions, demotions, bidding, external sourcing, and employment proposition. Step 102 may be supplemented by confirming position need. With reference to FIG. 1, the confirmation of position need may involve a control process with different levels of formality. Preferably, the district manager, or equivalent, may be engaged and provide controls to ensure that the staffing requirements are correct. Preferably, the control of the staffing goal may be set by a store manager, or an equivalent. Preferably, the system may not eliminate applicants based on the goal. Preferably, the system may not kick out associates on all cases. For example, an applicant that may not want to work Saturdays, but in an interview would agree to working Saturdays. Preferably, the system may not kick this applicant out before the interview.

Step 104 executes by identifying a plurality of candidates from an applicant source pool. The applicant source pool may be implemented over computer network, as disclosed above. Applicants may register their information, submit documents, and the like with the applicant source pool by accessing the computer network. For example, an applicant may submit employment information at a kiosk inside a store or other location of the company. The applicant source pool may include an internal applicant source pool with no contractual obligations, an internal applicant screening and selection with contractual obligations, and an external applicant source pool. Step 104 may be supplemented by screening and selecting internal applicants with contractual obligations. With reference to FIG. 1, this feature preferably involves a model of processes involved in managing the internal applicants with contractual obligations and the selection of candidates. If identified, then a standard status change process may be followed. Step 104 may be supplemented by screening and selecting internal applicants with no contractual obligations. With reference to FIG. 1, this feature preferably involves a model of processes involved in initial screening of candidates from the internal applicant source pool.

Step 104 also may be supplemented by performing initial screening on external applicants. With reference to FIG. 1, preferably the external applicant initial screening follows external sourcing efforts. External sourcing should preferably leverage all available mediums to attract new candidates to the organization. Referring back to step 102, there should be a continuous development of the applicant source pool that corresponds with the determined needs. An ongoing effort may be made to support the development of the applicant source pool. Preferably, external sourcing is maintained by certain activities, such as leveraging all available mediums to attract new candidates to the organization. Preferably, this includes monitoring of what positions are involved in the turnover. This information may be used for the sourcing strategy. Preferably, this includes sourcing on a proactive process. For example, staying in touch, on a regular basis with the local high school counseling office, or other career service entities. The feature also includes staying in touch with rehire candidates and creating a process or database that capitalizes on this process. The feature also includes conducting exit interviews to help with sourcing. Preferably, this information is kept at both the local and corporate level. Preferably, this feature includes adding to the original application how the candidate came to the store, location, or company, or how the candidate discovered the opportunity. For example, how many referrals have been made.

Step 106 executes by selecting the candidate from the plurality of candidates. Preferably, the hiring associate will communicate to the candidate the selection results. Step 108 executes by extending offer to the candidate. Step 110 executes by resolving the hire of the candidate by receiving acceptance, decline, or other action. If the candidate declines the offer, their application may be placed back into the application source pool to be considered for future opportunities. Alternatively, the declining candidate may not be considered for employment again either by the candidate or the hiring associate. Step 110 may be supplemented by a standard new hire process to be followed upon acceptance.

Step 106 may be supplemented by the following preferred embodiments and features. The following is for illustrative purposes, and in does not limit Step 106 in any manner. With candidate selection, staffing may include one or more processes and/or process steps. Candidate selection may include: assessment tools, background checks, realistic job previews, drug tests, interviews, peer reviews, compensation analyses, ranking, management review, and/or additional testing. The process may also include extending the job offer and subsequent negotiations, as disclosed in step 108. Some candidates may preferably come from internal screening of non-contractual applicants.

One feature may be an interview with all prospective candidates. This process may include one or more of the following business processes: Validate employment application and perform interview(s); Perform skills assessment (realistic job previews); If required, rank the interviewed candidates to create a short list. Preferably, there can be various levels of interviewing within this group. Preferably, depending upon the level and position, the intensity and depth of an assessment during the interview process is subject to variation. Other members of the organization may also be brought into the interviewing, assessment and/or ranking parts. Key Performance Indicators (KPI) may include: quality of candidates, retention and/or diversity. Controls may include: interviews with prospective candidates, organizational effectiveness (OE) approved questions, etc.

The process may preferably include determining whether additional testing or assessment should take place during the interview process to appropriately match required skills with position. This preferably involves use of available assessment tools to assist in further screening and selection.

The process may preferably include conducting an interview by the hiring associate who has the authority to make a hiring decision. Preferably, an interview guide will be provided to the hiring associate that focuses on weaknesses, gaps, admissions, omissions and/or legally acceptable questions. Preferably, this will include assessment scores, ranking, preliminary fit evaluation and/or applicant's preferences. An employment offer can preferably be conditional or non-conditional.

Preferably, roles and/or responsibilities within the disclosed processes may be as follows:

Organization: Store

Role: The new hire and rehire applicant

Role: Store Management with Primary HR Responsibilities

Organization: District Management

Role: The store operations management staff with district level responsibility

Organization Associate Relations Department

Role The associate relations department representative

Preferably, the following disclosed procedure may outline how a hiring associate will interview a selected candidate(s) and extend an employment offer. Also how to handle the candidate(s) that is not selected.

Preferably, this procedure can be prompted to be performed as follows (e.g., illustrative events): an applicant(s) has been initially screened and selected from the external applicant pool and an interview date and time has been setup with the candidate(s).

Preferably, this procedure can be performed as follows (e.g., an illustrative step-by-step process can include the following, including events and results):

1. Preferably, the hiring associate will be able to print a report of the interview dates and times. Preferably, the system will not keep a hiring associate from booking two interviews at the same time. It is preferably also store specific.

2. Preferably, the hiring associate will have the candidate complete any skills assessment (realistic job previews) prior to the interview.

3. Preferably, a structured interview is conducted with the candidate. Preferably, the hiring associate is provided with four interviewing tools:

a. A standard employment application;

b. A Quik Screen Output: an applicant evaluation that summarizes their responses to Quik Screen questions.

c. An assessment Output: an applicant evaluation that summarizes their responses to assessment questions. (In some illustrative embodiments, 2 and 3 may be combined into one document.)

d. A Structured Interview Guide Output: specific responses to identified questions generate follow-up questions along with preferably five standard questions:

Confirming the hours and days of availability;

Reviewing employment history (checking for gaps in employment, previous retail experience, reasons for leaving and/or references, etc.);

If applicable, reviewing criminal history;

Reviewing the job description, policies and/or procedures (benefits, probation and/or dress code, etc.);

If hired, confirming New Hire Data (e.g., rate of pay, start date and/or orientation date, etc.)

5. In some embodiments, the hiring associate may rank the interviewed candidates to create a short list for further interviewing.

6. A preferred next step is to extend an employment offer to the candidate. For some circumstances, this may be a conditional employment offer dependent on drug testing and/or background checking results.

7. Preferably, if the external candidate accepts the non-conditional employment offer, then they will proceed to a new hire process. Preferably, the hiring associate will update the candidate's record with, for example, the store number and the hire date.

8. Preferably, if a conditional employment offer is extended to the candidate, then one proceeds to the conditional offer handling procedure.

9. Preferably, if an applicant is interviewed and not hired, then the hiring associate should select an Interviewed-Not-Hired option on the applicant log and then select an appropriate reason from a drop down box. In some illustrative embodiments, possible values may include, for example, one or more of the following:

availability;

work history;

interpersonal skills;

not suited for position;

loss prevention;

travel requirements;

conflict of interest;

grooming standards;

poor references;

refused background check;

refused drug test;

refused union participation;

failed background;

failed drug test; and/or

other

In a Comment Field or the like, a hiring manager preferably may be required to manually enter an effective date.

10. Preferably, for those candidates that are not hired, an optional step is to notify the candidates that they have not been selected.

Preferably, each entity will preferably have its unique interviewing and selection guidelines, but in some preferred embodiments all applicants will come through a specific system.

Preferably, the skills needed to perform the disclosed procedure may include basic computer skills and interviewing skills. Preferably, the knowledge needed to perform this procedure includes knowledge of the operation companies' hiring guidelines

Lead Time:

Preferably, the time of this procedure occurs following the initial screening of external applicants

Duration:

Preferably, the length of time for the procedure includes that: the hiring associate will need about 15-25 minutes to process one candidate through this procedure. Preferably, the candidate could be in the procedure about 25-180 minutes depending on whether additional skills assessing is done (e.g., this may be operation company specific).

Frequency:

This preferably occurs for each external employment candidate at the store. Guidelines/Policies Influencing This Procedure:

The hiring guidelines of the operation company may influence this procedure. Information Used In This Procedure:

Hiring guidelines and structured interviewing tools may be used. Preferably, the following are taken into consideration: equal opportunity employment practices; the Americans with Disabilities Act; any relevant union requirements to hire people with Union seniority; etc.

Preferred supporting tools used:

1. Job Application—A standard employment application (e.g., form);

2. Applicants Results Summary—applicant evaluation that summarizes their responses to Screening questions.

3. Assessment Output—applicant evaluation that summarizes their responses to assessment questions.

4. Structured Interview Guide Output—Specific response options generate follow-up questions along with standard questions. Preferably, this includes 5 or so standard question prompts, custom qualifying question prompts and/or assessment question prompts.

In illustrative embodiments, five standard questions can include, for example:

Confirm the hours and days of availability;

Review Employment History (e.g., to check for gaps in employment, previous retail experience, reasons for leaving, references, etc.)

If applicable, review criminal history;

Review the job description/policies & procedures (benefits, probation, dress code); If hired, confirm New Hire Data (rate of pay, start date, orientation date).

In preferred embodiments, the deliverables of the process may include at least one candidate that has accepted an employment offer.

Preferably, some performance indicators (measurements) may include: freeing up store manager time. Preferably, some performance indicators measurement systems (e.g., scorecards) may include: decreasing the amount of time spent conducting interviews because of higher quality interviewees.

Preferably, controls that exist may include a preventive control to prevent people from hiring uncompetitive applicants. Preferably, these are automated controls that involve the separation of duties.

Preferably, the disclosed process may include a standard status change process to be followed.

The hiring associate may preferably provide the required release documents to the candidate when the employment offer is extended. Preferably, the required release documents are auto-populated and ready for printing through the administrative system.

The selected candidate may preferably receive the verbal and/or written offer with appropriate conditional requirements and release documents. Preferably, the conditional requirements may be outlined to the candidate. The process may preferably be outlined how a candidate will meet the conditions of a conditional offer of employment.

Preferably, this procedure may be prompted to be performed where a candidate has been extended a conditional offer of employment during the candidate selection and extension of offer procedure.

Preferably, this procedure can be performed using some or all of the following process steps.

1. The hiring associate has extended a conditional offer of employment to the candidate, so they will provide the required release forms to the candidate before proceeding.

2. The candidate will then need to consider the offer. If the candidate accepts, the candidate will need to sign the required release forms.

3. If the candidate accepts the offer, then the hiring associate should accept the required releases and schedule the required drug test and/or background checks.

4. The candidate will then complete the scheduled tests. In some embodiments, drug testing may be the only pre-employment testing done and such may not be done at all affiliated entities or operational companies in some cases where multiple entities are involved. In other embodiments, pre-employment background checking may also be included.

5. Preferably, the testing organizations will then provide the results to the appropriate authority (e.g., the appropriate authority within the operational company (“OpCo”).

6. Preferably, the appropriate authority within the OpCo will then notify the hiring associate of the results.

7. Preferably, if the results are favorable, the hiring associate will proceed with the new hire process. Preferably, the hiring associate will need to update the hire date and store number on the ARSS2 applicant record. ² ARSS=Applicant Recruiting, Screening and Selection.

8. If the candidate declines the conditional offer, the hiring associate should preferably record the same record in the ARSS applicant notes section that the candidate declined the test.

9. If the results are unfavorable, then the hiring associate should notify the candidate of the results and of the decision to not hire them.

10. The hiring associate should record in the applicant notes section that the candidate failed the conditional test.

Preferably, the OpCo's policy on pre-employment drug testing and/or background checking will guide the hiring associate.

Preferably, the skills needed to perform this procedure include computer literacy and hiring decision skills. Preferably, the procedure specific knowledge needed to perform this procedure includes knowledge of the OpCo's conditional employment processing.

Lead Time:

In preferred embodiments, this occurs when a conditional employment has been extended to an external store candidate.

Duration:

Preferably, this occurs for a length of time that includes: a) extending the employment in minutes; and/or b) drug testing and/or background checking being dependant on circumstances and dependent on the vendor used.

Frequency:

Preferably, this occurs for each external employment candidate at the store that is extend a conditional employment offer. Guidelines/Policies Influencing This Procedure:

Preferably, the OpCo's conditional employment policies influence this procedure.

Source Of The Information Used In This Procedure:

Preferably, the conditional employment policies establish what needs to occur and the vendor(s) provide the result(s).

Supporting Tools Used:

Preferably, some of the supporting tools used include drug testing and/or collection devices. Preferably, the deliverables include a conditional employment result.

Preferably, the candidate will notify the hiring associate of acceptance of the conditional offer requirements. Preferably, this will be done by signing a release document(s).

The process may include steps to accept a signed release and schedule drug testing depending on the OpCo. Preferably, the vendor consolidation project will determine the standard vendor. It will also preferably establish the drug testing panel. Preferably, it will then be up to the OpCo to determine who will be tested. Preferably, the location will be established in the process. Need to be able to note when the drug test is scheduled.

Preferably, the candidate has taken the drug test according to the OpCo procedure. Preferably, the hiring associate cannot continue the selection process until the conditional required results are received. Preferably, the process includes notification by the appropriate organization of test results. Preferably, the hiring associate will review the results, which are preferably communicated electronically. Preferably, the candidate is contacted, which is preferably done face-to-face or over the telephone, to notify them that their test results have disqualified them from being hired. Preferably, if there are additional candidates on the short list, then return to the list and extend an offer to the next candidate.

Preferably, the hiring associate will update the candidate's online record by selecting the appropriate option from a drop down box. Preferably, in an administrator sub-system, there will be a drop down box that will denote the current status of the candidate. Preferably, there is a way to note that a candidate turns down an offer of employment and why. In one example, a “pick list” can be provided. Preferably, the candidate's record has been updated to reflect the current status.

Preferably, a vendor consolidation project will determine the standard vendor. It will also preferably establish the standard checking approach. It will then preferably be up to the OpCo to determine who will be checked. The location will be established in the process.

The disclosed process may include notifying hiring associate of rejection of conditional offer requirements Preferably, a candidate elects to decline the offer and notifies the hiring person. Preferably, the hiring person will record that an offer was declined. Preferably, a date, a pick list position and/or a pick list reason will be documented.

This disclosed process also includes updating the candidate's record to denote that they are not to be considered for employment. Preferably, the hiring associate will update the candidate's online record by selecting the appropriate option from a drop down box. Preferably, in the administrator sub-system, a drop down box will denote the current status of the candidate. Preferably, there is a means to confirm that a candidate turns down an offer of employment and why. In some embodiments, a “pick list” will be provided.

The disclosed process also may include updating the candidate's record to reflect the current status. Preferably, if there are additional candidates on the short list, then return to the list and extend an offer to the next candidate.

The disclosed process also may include notifying candidate(s) not selected for the position. Preferably, the candidates on the short list may need to be notified that they were not selected. This notification is preferably communicated with a caveat, that if the selected candidate fails the conditional tests then they will be considered. This may be optional by OpCo. Preferably, the administrative system tracks candidates that have made it to a short list but not selected. This can be especially helpful if a second search is commenced shortly after this rejection notice was sent to the not selected candidate.

Preferably, the candidate, if appropriate, is notified that they were not selected.

The disclosed process may include updating the candidate's record to denote they were not selected. Preferably, the hiring associate may denote in the administrative system that the candidate has been interviewed, but not hired. Preferably, the system should enable denoting that the candidate was “not hired, but qualified” and/or “not hired, and not qualified.” Preferably, the candidate's record has been updated to reflect the current status.

The disclosed process may include external applicant initial screening. Preferably, if there are additional candidates, the hiring associate may return to the short list for the next candidate. If required, the interviewed candidates may be ranked to create a short list. Preferably, if multiple candidates have made it through the screening and selection, and assuming that not all candidates can be hired, the top candidate(s) of this short list should proceed. Preferably, the remaining short list candidate(s) will be told a candidate(s) has been selected to continue through the selection process. They will also preferably be told that if the selected candidate(s) is not selected, that they will be considered next.

The disclosed process also includes actions to be taken when the drug results are determined. Preferably, a standard drug testing vendor has completed the established standard panel. The disclosed process may notify the hiring associate of the drug test results. Preferably, a standard drug testing vendor communicates the results to the appropriate associate, such as, appropriate associate for the OpCo. In some illustrative cases, this may involve another human resources representative other than the hiring associate.

The disclosed process also may indicate when background checks are determined. Preferably, the standard background checking vendor has completed the established standard background check. Preferably, the standard background checking vendor communicates the results to the appropriate associate for the OpCo. In some illustrative cases, this may involve another human resources representative other than the hiring associate. In some embodiments, this feedback may be done through an electronic backfeed to the administrative system.

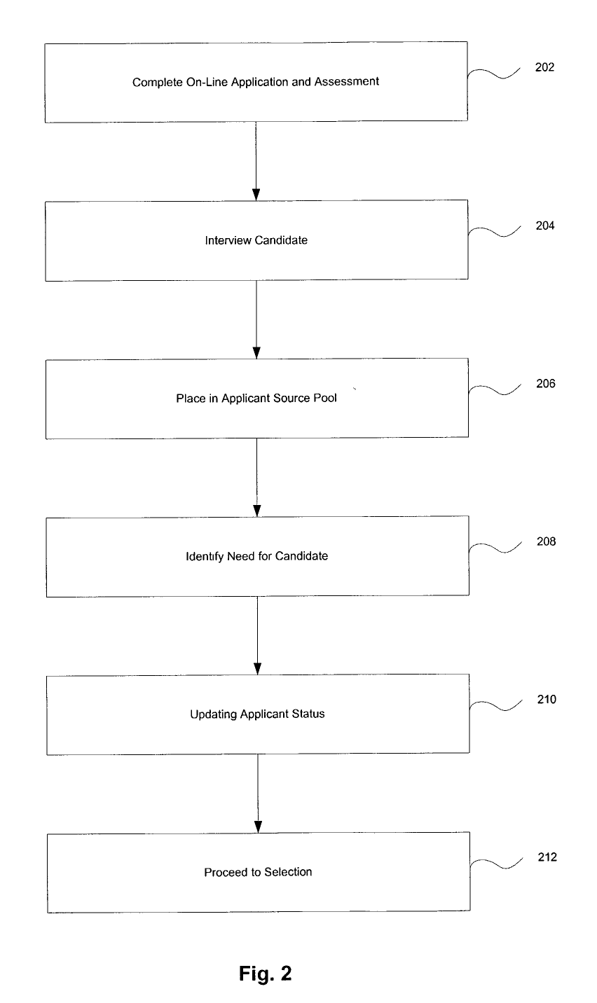

FIG. 2 depicts a flow diagram of external applicant initial screening according to some illustrative embodiments. With respect to external applicant initial screening, in preferred embodiments of the invention, this may include one or more processes and/or process steps as disclosed below. Preferably, external applicant screening follows sourcing efforts. Sourcing may preferably leverage all available mediums to attract new candidates to the organization. Key performance indicators may include:

1. Increase quality of candidates;

2. Increase appropriate fit to position, which will increase tenure;

3. Decrease vacancy rate of positions;

4. Store Manager has a centralized/standard tool for external sourcing;

5. Moved from a local level to strategic level for external sourcing;

6. Enabling the HR dept. to be proactive instead of reactive; and/or

7. Expanding the pool in a non-discriminatory way to meet organizational effectiveness.

Preferably, an applicant has come to the point where they would like to apply for employment. In preferred embodiments, this applicant may be a walk-in, an Internet surfer, a job fair participant, and/or can be from any other external source.

Step 202 executes by the applicant completing an on-line application and assessment. Preferably, an application and assessment is completed on-line through a computer workstation or Kiosk. Preferably, the system provides the following to the user of a Kiosk or the like:

1. The user completes the process electronically, rather than via a paper-based process;

2. The user uses an electronic interface via a computer at the Kiosk or the like.

3. The system preferably provides a number of selectable languages to accommodate users.

4. Preferably, prompt or immediate assistance is provided if problems occur with using a Kiosk.

Preferably, a state of the art application process is provided that takes less than 30 minutes. Preferably, the system moves the candidate through the tedious process of completing the required fields while inviting them into the organization. Preferably, all positions available in the store will be perpetually posted. Preferably, the applicant has completed the online script that has collected employment application information. Additionally, a number of questions have also preferably been answered to facilitate an initial assessment.

Preferably, the applicant has applied in the store and the assessment has determined the applicant to be competitive. The applicant then is preferably notified at the closing of the application process to go to the hiring associate for more information. Preferably, the hiring associate may then do an on the spot initial screening interview.

Step 204 executes by interviewing candidate. Interviewing may be accomplished by the hiring associate. The candidate may be notified of interview date and time, and to confirm location of interview. Preferably, a verbal notification of the interview date and time is provided to the candidate. In some cases, the interview may be conducted immediately. In preferred embodiments, the candidate must be told what is expected of them when they come for an interview, such as what identification may be required of them if they are hired.

Step 206 executes by placing applicant in the applicant source pool. The applicant source pool preferably resides on a computer network, and may be accessed by different entities in different locations. For example, person or persons doing the hiring should be able to sort through the applications in the applicant source pool to identify possible applicants. This process is discussed in greater detail below, and with reference to step 206. However, sorting and filtering of applicants may also occur in other steps, and is not limited to step 206.

In this process, the administrator component of the system will preferably allow applicant sorting and filtering. Preferably, there will be many different variables available so that an extract of the applicant pool can be created.

Preferably, this procedure will detail how a hiring associate will sort and/or filter the applicant pool to identify possible interview candidate(s). Preferably, once a candidate(s) has been identified, the hiring associate will need to setup an interview time with the candidate(s). In this procedure the hiring associate can be in the store, district or associate relations department.

In preferred embodiments, this procedure is prompted by a need to hire an hourly store associate. Preferably, hourly store management applicants will go through this procedure but salary management level applicants will be directed to a different process.

Preferably, this procedure can be performed using some or all of the following steps:

1. The hiring associate will launch the administrator side of the ARSS system. Those that should have access to the admin side of ARSS will preferably be assigned an ID and PIN number. Preferably, the ID and PIN allow the system to know what data to display. Preferably, the ID and PIN are numeric. In embodiments where multiple entities or operational companies access the system, the ID will preferably be a smart number based on operation company, geographic region and the like (e.g., OpCo, Region, District and/or Store). Preferably, the PIN will be, for example, the authorized associate's last 4 digits of their social security number (SSN) or other suitable PIN.

2. The primary screen will preferably launch with the last 30 days of applications for a specific store. Preferably, the initial sort of the applications will be by level of “competitiveness” (note: this may be highlighted or coded to facilitate review, such as, e.g., green, yellow, red, purple or the like) and then a further sort of the applications will be by date (e.g., most recent to oldest).

In some illustrative embodiments, candidates may be color and/or symbol coded to facilitate review, such as for example:

a. Competitive=green/smile J

b. Marginal=yellow/straight line K

c. Non-Competitive=red/sad face L

d. Pre-Qualified-Fast Exited=purple/X

In some illustrative embodiments, default columns may include:

a. Apply Date—system date/time stamps;

b. Location Applied At—system enters;

c. Name (F&L)—applicant enters;

d. Phone—applicant enters;

e. Position—applicant selects;

f. Notes—an asterisk indicates if action has been taken on this applicant;

g. SSN—applicant enters; and/or

h. Store Hired At—administrator enters (The filtering option in step 3 will allow the viewing of new hires).

In some illustrative embodiments, a superset of columns may include:

a. The point of entry into the system (e.g., application via the Internet, application via a Kiosk, IVR application;)

b. WOTC status; and/or

c. Quik Screen Evaluation

In some illustrative embodiments, the system will provide the following sort capabilities: enabling the sorting of any column by clicking on it: first click is preferably ascending sort; second click is preferably descending sort.

3. The hiring associate will preferably be able to search and/or filter 1 year of applicants (or another time period of applicants) by using one or more of the following fields:

Name: e.g., full or part first; full first and full or part last; and/or full last or the like;

Primary position;

Social security number;

Applicant status (e.g., static options such as for example: hired; non hired; pre-qualified; non pre-qualified; etc.);

Application date range; and/or

A combination of the above.

Preferably, within X miles of zip code Y will not be active on this screen.

4. If no candidates are found in the store applicant pool, preferably the hiring associate will launch the operating company applicant pool screen. In preferred embodiments, to clearly identify the site as the corporate pool, a message “Welcome to the [OpCo] Corporate Pool!” or the like can be displayed. Preferably, this applicant pool launches with the last 30 or so days of applicants across the operating company (e.g., preferably, new hires are not in this list). Preferably, applicants are pushed from the store pool to the OpCo pool three or so days after the application is submitted. Preferably, the default columns, superset of columns, competitiveness color and/or symbol, and/or the sort capabilities are substantial or entirely the same as the store pool.

5. The hiring associate will preferably be able to search and/or filter about 1 year of OpCo pool applicants by using one of the following fields:

Application home store (e.g., this will preferably be able to set a default search of up to about 15 stores);

Name: full or part first; full first and full or part last; full last or the like;

Primary position;

Social security number;

Applicant status (e.g., static options: hired; non hired; pre-qualified; non pre-qualified; etc.)

Application date range;

Within X miles of zip code Y; and/or

A combination of the above.

Preferably, each column in the initial primary screen can be clicked on to sort the applicants.

6. Preferably, when the hiring associate has identify an interview candidate, they will call the candidate to setup an interview time.

7. At this point, the hiring associate should preferably update the candidate's ARSS application with the appropriate entry (e.g., via an ARSS Applicant Notes section):

a. Interview Scheduled: an interview has been scheduled with the date and time.

b. Interview-Declined by Applicant: a drop down box allows the selection of the reason why the applicant declined the interview:

Unwilling to accept part time;

Unwilling to travel;

Benefits are not sufficient or waiting period is too long;

Position offered is unacceptable;

Position offered is unacceptable;

Salary;

Scheduling;

Found another job/Better offer;

Does not want to joint a union;

Did not like the automated hiring process; and/or

Other

Preferably, in a Comment Field the hiring associate must manually enter an effective.

Call Placed: the date the first call was made can be entered.

c. 2^{nd} Call Placed: the date the second was made can be entered.

8. The hiring associate will preferably have responsibility for maintaining the Applicant Notes section. The applicant notes section is where interviews are scheduled and actions that have been taken to interview the applicant are noted.

An asterisk (*), or other suitable indicator, in the Notes column on the primary screen will preferably indicate that a hiring manager has taken action on this applicant;

Preferably, all entries made are displayed, no entry can be deleted or overridden, and they are listed from most recent (e.g., system stamps date).

Preferably, a drop down menu of options include:

a. Interview Scheduled;

b. Call Placed;

c. 2nd Call Placed;

d. Interview-Declined by Applicant;

e. Interviewed-Not Hired;

f. Drug Test; and/or

g. Background Check (if desired)

9. The hiring associate will preferably then take the candidate(s) that have accepted an interview into the candidate selection process.

10. If no candidate(s) is found, then the hiring associate may need to work with available resources to create a recruiting plan.

11. Preferably, the hiring associate will be able to access the Applicant Tool Kit by clicking on an applicant record. Preferably, the tool kit will:

Display what stage/title that the applicant is:

Applicant

New Hire (e.g., entering store number hired at and/or date hired);

Display store that the applicant applied at;

Display store hired at e.g., entering this information before being allowed to print forms);

Display Pre-Hire Outputs; and/or

Display Post-Hire Outputs.

In illustrative embodiments, the following business rules for the field apply:

An applicant stays within the home store applicant pool for about 72 hours and then is pushed to the operating company pool. The applicant can preferably elect to not be considered by more than one store.

Preferably, all applicants go through the applicant recruiting, screening and/or selection processes.

To perform this procedure, an individual should be able to identify candidates from a list of applicants, to have some computer literacy.

Lead Time:

Preferably, this occurs when a position in the staffing plan is open or in some cases a quality applicant has been identified.

Duration:

Preferably, this procedure can take, for example, about 5-30 minutes depending on the number of applicants being processed in a session.

Frequency:

Preferably, this procedure occurs whenever there is a staffing need in a store (e.g., in some embodiments only those that are not a salary position). Guidelines/Policies Influencing This Procedure:

Preferably, the hiring policy of the operating company influence this procedure.

Source Of The Information Used In This Procedure:

Preferably, the employment application and the ARSS assessment results.

Supporting Tools Used:

1. Job Application—Standard employment application;

2. Quik Screen Output—applicant evaluation that summarizes their responses to Quik Screen questions;

3. Assessment Output—applicant evaluation that summarizes their responses to the assessment questions;

4. Structured Interview Guide Output—Specific response options generate follow-up questions along with standard questions. For example, this can includes 5 standard question prompts, custom qualifying question prompts, and assessment question prompts.

### FIVE STANDARD QUESTIONS:

A. Confirm the hours and days of availability;

B. Review Employment History (check for gaps in employment, previous retail experience, reasons for leaving, references);

C. If applicable, review criminal history;

D. Review the job description/policies & procedures (benefits, probation, dress code);

E. If hired, confirm New Hire Data (rate of pay, start date, orientation date).

Preferably, the deliverables include the overall assessment of each applicant, which reduces the time required by the hiring associate to select interview candidates. See the tools section above for the five deliverables created by the system for the initial screen and later in the interviewing.

In some embodiments, key performance indicators (measurements) may include:

1. WOTC Capture: Percentage of Certified Eligible Associates

2. Freeing up store manager time for reviewing applications, setting up interviews and conducting interviews.

Key performance indicators measurement system, e.g. scorecard:

1. Take the number of certified associates and divide it by the total number of new hires. This may be done by vendors.

2. Survey store managers.

Preferably, only competitive applicants can be hired, so the noncompetitive will not be processed.

Specification:

Preferably, this filter can search and sort at least some of the following and/or other items:

Scheduling availability;

Must identify original store;

Geographic preference for those that are willing to travel X miles;

Store for those persons only willing to work at a specific location; and/or

Requirements for accommodations.

Step 208 executes by identifying a need for a candidate by a store or other entity. The applicant source pool may be sorted over a computer network, as disclosed above. For example, non-management opening in store operations has been identified and appropriate approval has been received to fill the open position. Preferably, this approval may come from a discussion with the district manager and/or possibly the HR associate relations representative.

A process that may preferably be included is that the candidate is verbally notified that they have been selected for further interviewing and screening. Preferably, the candidate has been identified as “competitive” and meets the qualification of the opening. Here, key performance indicators may include for example: timeliness which can be measured by date/time of application versus date/time of review and notification of consideration. Preferably, a drop down list will be provided that states when someone was called for an interview. In some embodiments, there may be a date option and/or an option to hold the person at the store. It will also preferably allow them to note the interview time. The candidate preferably has the option to accept the interview invitation, decline the interview invitation and stay active and/or to decline and request to be removed from further consideration.

Step 210 executes by updating the applicant's status according to the outcome of the interviews, and the querying of the applicant source pool. This step may include updating the candidate's record to denote that they wish to be considered for future employment. The hiring associate may preferably update the candidate's online record by selecting the appropriate option from a drop down box, preferably as part of a screen. Preferably, the administrator side of the system will have a drop down box to denote the current status of the candidate. Preferably, on the applicant log, the system will sort/filter applicants that have declined an initial immediate offer, but that want to remain in the pool. Preferably, the system will place a future hire date when a student or other applicant can't start immediately. Preferably, the applicant will pre-populate when they can start and have it reported to the hiring manager. Preferably, the system will capture the process of going to see a store manager if they are a green candidate. Thus, the candidate's record may be updated to reflect the current status.

Step 210 also may include updating a candidate's record to denote that they are not to be considered for employment. The hiring associate may preferably update the candidate's online record by selecting the appropriate option from a drop down box. In the administrator sub-system, a drop down box may be provided that may denote the current status of the candidate. Preferably, a way is provided to note that a candidate turns down an offer of employment and why, such as a “pick list” or the like. Preferably, the candidate's record has been updated to reflect the current status.

Step 212 executes by proceeding to the selection process, as disclosed above. The candidate may be included on a list of possible candidates. Further, a recruiting approach may be determined, and the open position marketed. Based on the determined staffing strategy, the hiring associate, such as the district manager and/or the store management, or the like, may develop a strategic approach to fill and maintain the sourcing pool. Thus, the recruiting process may be followed to increase applicant flow to the applicant source pool.

Referring back to step 202, an applicant may complete an on-line application and assessment, especially if they are external applicants. With respect to an online applicant and initial screening, in preferred embodiments of the invention, this may include one or more processes and/or process steps as disclosed below. Preferably, a web-based system may allow application completion and initial screening to occur through an in-store kiosk and/or through a web connected device.

For example, an applicant wants to apply for employment. In this process, an applicant has come to the point where they would like to apply for employment. In some illustrative cases, this applicant may be a walk-in applicant that accesses a computer workstation or kiosk, an internet surfer, a job fair participant or may be an applicant from any other external source.

In some preferred embodiments, a “splash page” may be provided to attract applicants. Further, basic instructions on how to navigate throughout the site may be provided to the user. Explanations may be provided of the process and/or kiosk operation. Additionally, information encouraging applicant to apply for the position and company is provided.

In this process, the location selection is provided by the applicant. For example, when an applicant applies via the Internet, an identifier needs to be included to identify the location desired. In contrast, in preferred Kiosk embodiments, the particular Kiosk is preferably configured to automatically identify that store location.

In this process, preferably demographic information is gathered such as for example First & Last Name and SSN to create applicant record and to ensure no duplicate application(s).

In this process, the system will ensure that the applicant meets minimal hiring requirements of all employees (e.g., that they are willing to take a drug test in some embodiments, etc.).

This process is preferably used to communicate open positions (as well as to provide position descriptions, such as responsibilities, hours, salaries, etc.) and to allow applicants to select the position(s) that they are interested in applying for during the session.

In this process, the applicant is presented with a number of questions (e.g., 14 in the illustrative embodiment) and a custom script is used to assist in the automatic screening and selection of applicants.

In this process, questions are presented to the applicant to assist in the screening and assessment process related to integrity, service and turnover and/or other assessment needs.

In this process, the applicant fills in the job application form to gather the applicant's personal, education and/or employment information and the like.

In this process, the applicant has the opportunity to review and, if necessary, edit their personal, education and/or employment history and the like.

In this process, the Applicant reads and clicks “I Agree” or “I Disagree” or the like to agree to terms related to application or the like.

In this process, a user may submit gather race and/or gender information (preferably, optionally) and/or military status (preferably, optionally) for equal opportunity and/or other appropriate needs.

In this process step, questions may be presented to ascertain applicability of WOTC (e.g., to ask Work Opportunity Tax Credit questions).

In this process, research can be conducted.

In this process, the system can provide a “Close” and/or “Thank you” message to confirm completion or the like and/or a “SUBMIT” button.

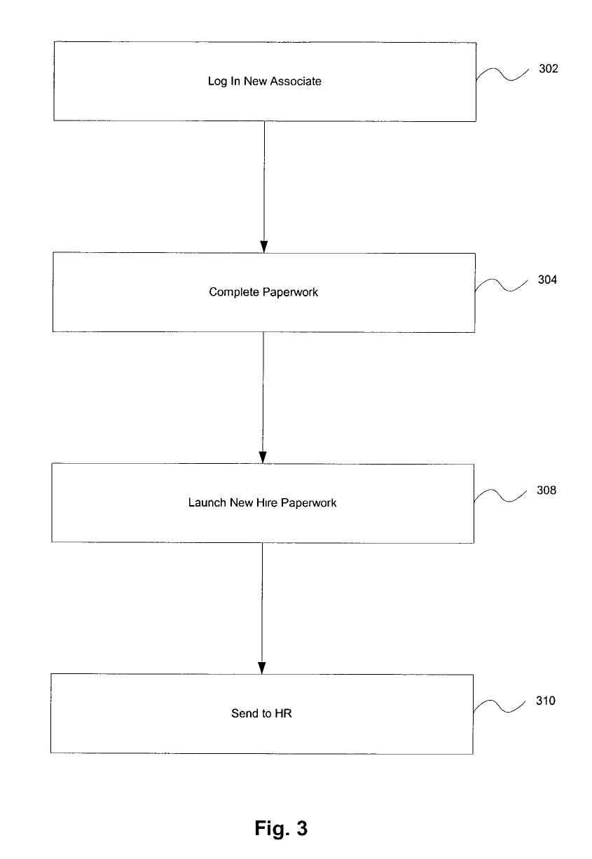

FIG. 3 depicts a process flow diagram of new hire authorization for external store applicants according to some illustrative embodiments. With respect to new hire authorization, in preferred embodiments of the invention, this may include one or more processes and/or process steps as disclosed below. The process may, for example, be used to process required forms for the new hire from a computer network or automated system.

In illustrative cases, the following roles and/or responsibilities may be present:

Organization: Store

Role: new hire and rehire

Role: store management with primary HR responsibilities

Organization: District Management

Role: The store operations management staff with district level responsibility

Organization: Associate Relations Department

Role: The associate relations department representative

In preferred embodiments, a new hire processed through the system will complete new forms. This process is preferably prompted to be performed once a candidate has been selected and has accepted an employment offer, and, preferably, once some or all conditional requirements have been met.

In preferred embodiments, this procedure can be performed using some or all of the following steps:

1. While logged into the system, the new hire will enter their social security number (SSN), or other identifier, to complete a “2nd event.” Preferably, only applicants with a status of “New Hire” will be allowed to complete the 2nd event (preferably, this is still overseen and/or manually controlled by the administrator).

2. Preferably, the new hire will complete an array of questions and fill in fields over several screens.

3. When the new hire has completed the required fields, the hiring associate will preferably log into the administrator side of the system.

4. The hiring associate will preferably select the new hire and open or launch an Applicant Tool Kit whereby the post hire forms can be generated and printed.

5. In some embodiments, when the forms are printed, the hiring associate will need to complete the employer portion of the forms by hand, but an administrator side program can be adapted to automatically populate this information.

6. Once printed, the new hire will sign all of the appropriate forms.

7. Then, all of the required forms are preferably placed into a new hire envelope and sent to headquarters or otherwise appropriately processes.

8. In some embodiments, if the new hire is WOTC eligible, then the new hire and the hiring associate may complete the required WOTC forms where needed and mail them to the appropriate vendor.

Preferably, all forms are completed properly and sent to the appropriate destination.

To complete this procedure, one should have a general understanding of the forms and how to complete them.

Lead Time:

Preferably, this procedure occurs when the candidate has been hired.

Duration:

Preferably, this procedure will take about 15 minutes.

Frequency:

Preferably, this procedure will occur for each New Hire/Rehire.

Guidelines/Policies That Influence This Procedure:

Preferably, certain questions are only asked post-offer (e.g., their Date of Birth, Race, Sex, Military Status, etc.).

Source Of The Information Used In This Procedure:

Preferably, this may include for example: 1-9 Form, test results, position specific information, etc.

The deliverables can include complete and accurate hiring authorization forms. The forms can be used, for example, by payroll, human resources, etc., to, for example, set up the associate on CYBORG, to receive a paycheck, etc. Preferably, the deliverable is retained long-term or permanently, such as electronic or hard copy files.

Key performance indicators include that: new-hire paperwork may be completed more thoroughly and/or accurately through this system and the percent of new-hire paperwork that needs to be re-worked will decrease. Additionally, the current time spent “on-the-clock” for completing new-hire paperwork (e.g., 30-60 minutes) by associates will be nearly eliminated.

Preferably, there are two signoffs used as a control—i.e., the associate and the manager.

Preferably, the trigger step for the disclosed process involves that the new candidate is selected.

Step 302 executes by logging in a new associate into the new hire portion of system. Preferably, in the process, the hiring manager will log the new associate onto the new-hire portion of the system. This portion of the paperwork may preferably be completed on a computer terminal, not at the publicly accessible kiosk, or the like. Alternatively, the paperwork may be completed at the kiosk, or other locations as needed.

Step 304 executes by completing the new hire paperwork. In this process, the selected candidate preferably completes the new hire paperwork using the ARSS system, or another online, or dedicated system.

Step 306 executes by launching completed new hire paperwork. In this process, the manager completing the hiring paperwork preferably launches the completed paperwork and prints for validation and signatures. In some embodiments, where legally sufficient, signatures may be provided electronically. However, in preferred embodiments, hard copies of documents will be printed for signature.

Step 308 executes by validating the new hire paperwork. In this process, the manager and new associate will sign the completed paperwork. The manager also reviews the paperwork for completeness and accuracy.

Step 310 executes by sending to human resources the paperwork in a new hire envelope. In this process, the new hire paperwork is preferably placed in the appropriate envelope and sent to the human resources department. The human resources office preferably receives the new hire paperwork and processes accordingly.

While preferred and illustrative embodiments of the invention have been described herein, it will be understood that the various embodiments of the present invention include any and all modifications, alterations and adaptations as would be appreciated by those in the art based on this disclosure and by practice thereof The present invention is not limited to the illustrative embodiments but includes any and all embodiments as may be appreciated by those in the art.

What is claimed:

1. A method for selecting a candidate for employment within a company, comprising:
determining a need for the candidate;
identifying a plurality of candidates from an applicant source pool, wherein the applicant source pool is implemented over a computer network accessible from a plurality of locations; and
selecting the candidate from the plurality of candidates.

2. The method of claim 1, further comprising extending an offer to the candidate.

3. The method of claim 2, further comprising placing the candidate back into the applicant source pool if the offer is declined.

4. The method of claim 1, wherein said identifying includes screening the applicant source pool for the plurality of candidates.

5. The method of claim 1, further comprising confirming the need for the candidate.

6. An employment application system at a variety of locations, comprising:
a server programmed so as to provide an interface for designating employment opportunities and to provide an on-line application form for applying for the opportunities;
a business location containing a kiosk, the kiosk being linked to the interface and having a display and input device to receive instructions from a user; and
an applicant source pool to receive employment information from the user and linked to the server, wherein the applicant source pool is queried to provide the employment information.

7. The system of claim 6, wherein the interface includes an entry page accessible via the Internet.

8. The system of claim 6, wherein the business location is a retail establishment.

9. The system of claim 6, further comprising another business location linked to the interface.

10. A method for authorizing a new hire for an external applicant within an employment system, comprising:
designating the new hire within a computer network for the employment system;
launching new hire paperwork from a storage coupled to the computer network, wherein the new hire paperwork correlates to the new hire;
validating the new hire paperwork for the computer network; and
sending the new hire paperwork to human resources.

11. The method of claim 10, further comprising accessing the computer network supporting the employment system.

12. A method for receiving and screening an application for employment, comprising:
completing an on-line application from a candidate at a location linked to a computer network;
interviewing the candidate;
placing the application from the candidate into an applicant source pool residing on the computer network; and
screening the applicant source pool for the candidate by correlating the application to a request.

13. The method of claim 12, further comprising identifying the request according to a need for the candidate.

14. The method of claim 12, further comprising updating a status of the candidate.

15. The method of claim 12, wherein the screening includes filtering the application.

16. The method of claim 12, wherein the location is a kiosk located inside a retail establishment.

17. The method of claim 12, wherein the location is a personal computer linked to the computer network via the Internet.

18. The method of claim 12, further providing an interface to the candidate at the location.
